(19) United States
(12) Patent Application Publication
(10) Pub. No.: US 2021/0371133 A1
(43) Pub. Date: Dec. 2, 2021

(54) ELECTRICAL POWER DISTRIBUTION INTEGRATED INTO A SATELLITE STRUCTURAL PANEL

(71) Applicant: THALES, Courbevoie (FR)

(72) Inventors: Marc BEKEMANS, CHARLEROI (BE); Philippe VANDEPLASSCHE, CHARLEROI (BE); Barbara MABED, GOSSELIES (BE)

(21) Appl. No.: 17/320,053

(22) Filed: May 13, 2021

(30) Foreign Application Priority Data
May 28, 2020 (EP) 20305560.3

(51) Int. Cl. B64G 1/42

(52) U.S. Cl. CPC B64G 1/428

(57) ABSTRACT

A structural panel for a satellite includes an external skin, an internal skin and a core layer arranged between the two, internal and external, skins and provided with a blind void comprising at least one electrically insulated inserted busbar.

### CROSS-REFERENCE TO RELATED APPLICATIONS

This application claims priority to foreign European patent application No. EP 20305560.3, filed on May 28, 2020, the disclosure of which is incorporated by reference in its entirety.

### FIELD OF THE INVENTION

The invention pertains to a structural panel for satellites and relates to the distribution of electrical power on board satellites. The exchange of electrical power between the batteries, the power conditioning unit and certain heavy consumers such as the payload takes place using electrical cables.

### BACKGROUND

The distribution of the direct current between certain items of equipment of the satellite requires the parallel placement of numerous wires in order to be able to conduct the current with minimum losses and to limit heating.

The problem is intensified in space applications because the cables are in vacuum and therefore cooling takes place mainly by radiation.

Thus, the interior of satellites generally features a nest of wires which covers the items of electronic equipment. This represents a not-insignificant onboard weight, the cost potentially being of the order of €40 000 per kilogram.

Another important point with the use of wires relates to electromagnetic interference. Specifically, the high-frequency electric currents allowed over these cables are limited in amplitude in order to limit the electromagnetic radiation. This means that equipment manufacturers have to place filters at input and sometimes at output, which further adds to the weight of the cable assembly subsystem.

### SUMMARY OF THE INVENTION

One aim of the invention is to overcome the abovementioned problems.

What is proposed, according to one aspect of the invention, is a structural panel for a satellite comprising an external skin, an internal skin and a core layer arranged between the two, internal and external, skins and provided with a blind void comprising at least one electrically insulated inserted busbar.

Thus, positioned at this location, the conductors are ideally cooled by conduction which allows the cross section, and therefore the weight, of the conductors to be minimized.

In one embodiment, the busbar comprises a set of electrically insulating layers and of electrically conductive layers such that each conductive layer is doubly electrically insulated by an envelope formed of two electrically insulating layers.

This double insulation makes the panel robust with respect to a fault in one of the two insulators. This double-insulation feature is required for space applications which have to be reliable and fault-tolerant.

According to one embodiment, the structural panel comprises a joining material filling the blind void in order to keep the inserted busbar fixed in place.

For example, the joining material is rigid foam, resin or glue.

According to one embodiment, a bar of the busbar comprises at least two electrical contacts that are intended to connect an element arranged outside the panel on the side of the internal skin.

Thus, it is easy to electrically connect two items of equipment.

In one embodiment, an electrical contact comprises two contact pads.

Thus, the panel is tolerant with respect to faults in one of the two contact pads. Heating due to a potential poor contact might damage the insulation and therefore the double insulation causing a short circuit between two bars of the busbar. The presence of a second contact in parallel prevents this heating by still providing at least one perfectly conductive path. This redundancy therefore increases reliability.

According to one embodiment, the core layer comprises a material with a cellular structure.

For example, the core layer comprises a material with a cellular structure that has a honeycomb structure.

Such a structural panel comprises a honeycomb layer: this is a very lightweight hexagonal cellular structure enclosed between two sheets of aluminium. The conductor placed between these walls is ideally shielded from an electromagnetic point of view, and consequently, larger high-frequency currents may flow therein. Measurements have shown that it is possible to increase the high-frequency currents in conductors held in these panels tenfold. This has a direct effect on the electrical filters which may be limited, making it possible to decrease weight and therefore cost.

In one embodiment, the inserted busbar comprises three bars, respectively corresponding to two different voltage sources and a common ground.

Also proposed, according to another aspect of the invention, is a satellite comprising at least one structural panel as described above.

### BRIEF DESCRIPTION OF THE DRAWINGS

The invention will be better understood from studying a few embodiments described by way of completely non-limiting example and illustrated by the appended drawings, in which:

FIG. 1 schematically illustrates a structural panel for a satellite, according to one aspect of the invention;

FIG. 2 schematically illustrates a busbar, according to one aspect of the invention;

FIG. 3 schematically illustrates a busbar and a connection, according to one aspect of the invention; and

FIG. 4 schematically illustrates a satellite, according to one aspect of the invention.

Throughout the1ures, elements having identical references are similar.

### DETAILED DESCRIPTION

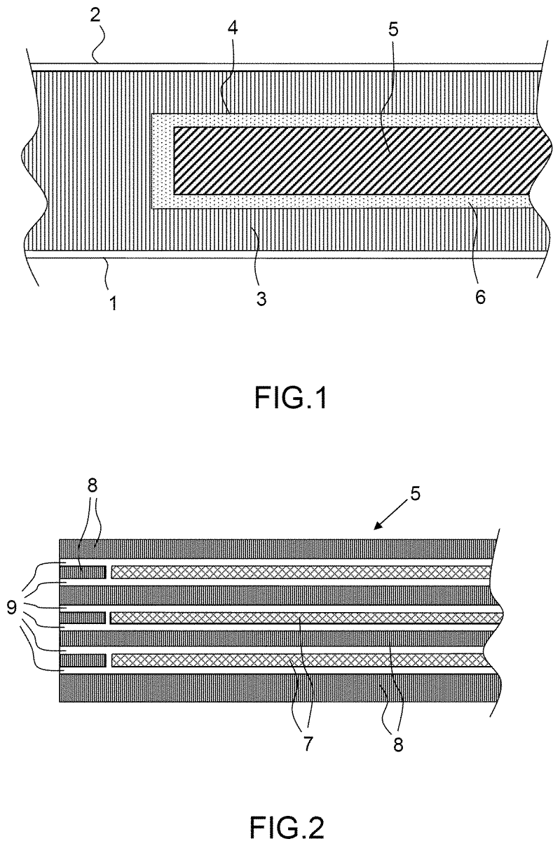

FIG. 1 shows, in cross section, a structural panel according to one aspect of the invention, comprising an external skin 1, which is for example electromagnetically shielded, intended to be on the outside of a satellite, an internal skin 2, which is for example electromagnetically shielded, intended to be on the inside of the satellite, and a core layer 3 arranged between the two, internal 2 and external 1, skins and provided with a blind void 4 comprising at least one inserted busbar 5. A joining material 6 fills the blind void 4 in order to keep the inserted busbar 5 fixed in place.

FIG. 2 shows, in cross section, the detail of a busbar 5 comprising a set of electrically conductive layers 7 and of electrically insulating layers 8 such that each conductive layer 7 is electrically insulated by an envelope formed of two electrically insulating layers 6. For example, the busbar 5 comprises three bars or conductive layers 7 that are electrically insulated by a respective envelope formed of two electrically insulating layers 6. Two contiguous layers are attached to one another by an adhesive layer 9, for example a prepreg.

The joining material 6 may be rigid foam, resin or glue.

The core layer 3 is, for example, a material with a cellular structure, or a material of rigid foam type.

Advantageously, the core layer 3 is a material with a cellular structure of honeycomb type. The honeycomb commonly called NIDA consists of a hexagonal cellular structure enclosed between two thin sheets of aluminium. The conductors placed inside this composite structure are therefore ideally shielded from an electromagnetic point of view, by construction. Consequently, larger high-frequency currents may flow without interfering with their surroundings. Measurements have shown that it is possible to increase the high-frequency currents in conductors trapped within a NIDA tenfold. This has a direct effect on the sizing of the electrical filters, which may be decreased in size and therefore in weight.

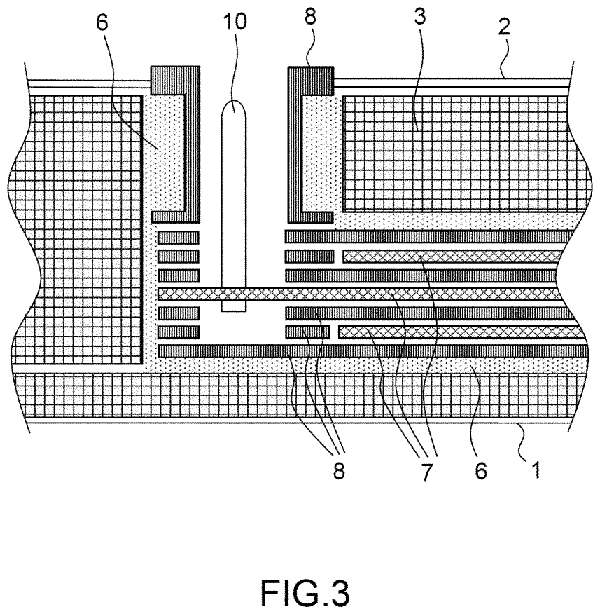

FIG. 3 shows an electrical contact 10 connected to a bar of a busbar 5, in cross section, according to one aspect of the invention. The connection between the electrical contact 10 and the bar of the busbar 5 may be made by soldering or crimping.

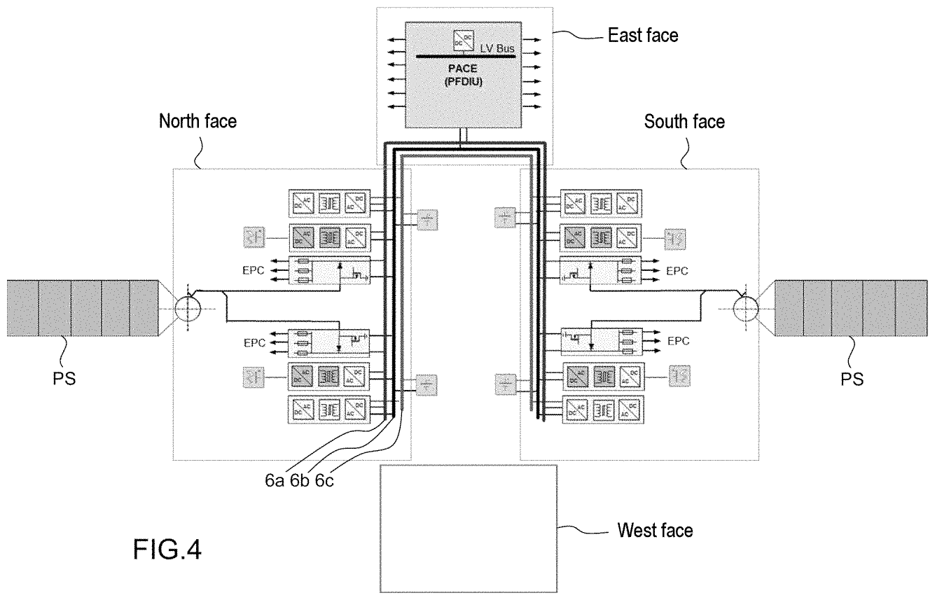

FIG. 4 schematically shows a satellite, the faces of which comprise structural panels as described above. The satellite therefore comprises, in its panels, a busbar comprising, for example, three bars: a high-voltage current bar 6a, a low-voltage current bar 6c and a common ground bar 6b.

1. A structural panel for a satellite comprising an external skin, an internal skin and a core layer arranged between the two, internal and external, skins and provided with a blind void comprising at least one electrically insulated inserted busbar, the busbar comprising a set of electrically insulating layers and of electrically conductive layers such that each conductive layer is doubly electrically insulated by an envelope formed of two electrically insulating layers, and the panel comprising a joining material filling the blind void in order to keep the inserted busbar fixed in place.

2. The structural panel for a satellite according to claim 1, wherein the joining material is rigid foam, resin or glue.

3. The structural panel for a satellite according to claim 1, wherein a bar of the busbar comprises at least two electrical contacts that are intended to connect an element arranged outside the panel on the side of the internal skin.

4. The structural panel for a satellite according to claim 3, wherein an electrical contact comprises two contact pads.

5. The structural panel for a satellite according to claim 1, wherein the core layer comprises a material with a cellular structure.

6. The structural panel for a satellite according to claim 5, wherein the core layer comprising a material with a cellular structure has a honeycomb structure.

7. The structural panel for a satellite according to claim 1, wherein the inserted busbar comprises three bars corresponding to two different voltage sources and a common ground.

8. A satellite comprising at least one structural panel according to claim 1.
